(19) United States
(12) Patent Application Publication
(10) Pub. No.: US 2015/0066708 A1
(43) Pub. Date: Mar. 5, 2015

(54) SERVER AND METHOD FOR PROVIDING PLAYBACK SERVICE OF DIGITAL CONTENT

(71) Applicant: DeNA Co., Ltd., Tokyo (JP)

(72) Inventors: Shinya MASUDA, Tokyo (JP); Tomoyuki SHIMADA, Tokyo (JP); Ryu ORIKASA, Tokyo (JP)

(73) Assignee: DeNA Co., Ltd.

(21) Appl. No.: 14/469,578

(22) Filed: Aug. 27, 2014

(30) Foreign Application Priority Data
Aug. 28, 2013 (JP) 2013-177006

(51) Int. Cl. G06Q 30/06; G06F 21/10

(52) U.S. Cl. CPC G06Q 30/0641; G06F 21/10
USPC 705/27.1

(57) ABSTRACT

One object is to allow users to enjoy digital contents more easily. The server according to an embodiment can execute a program including: a service control module; a screen sending module configured to send, in response to a request from a terminal, screen data of screens including a playback instruction screen for making an instruction for playback of a musical piece; a mode setting module configured to set, for each user, a playback starting mode selected from a plurality of modes including Normal mode and One-tap Playback mode; a playback control module configured to start playback of a musical piece; and a possession state update module configured to update a possession state of playback tickets in response to playback of the musical piece.

### CROSS-REFERENCE TO RELATED APPLICATIONS

This application is based on and claims the benefit of priority from Japanese Patent Application Serial No. 2013-177006 (filed on Aug. 28, 2013), the contents of which are hereby incorporated by reference in their entirety.

### TECHNICAL FIELD

The present invention relates to a server and method for providing a playback service of digital contents and, in particular to a server and method for providing a playback service of digital contents to users operating a plurality of terminals communicatively connected.

### BACKGROUND

Conventionally known such servers include a server for providing a service of distributing digital contents such as musical pieces to clients connected via a network such as the Internet (see Japanese Patent Application Publication No. 2006-524874). In such a service, when a user makes an instruction for purchase on a screen for purchasing digital contents (e.g., by selecting Purchase button in the screen), distribution of a digital content begins along with a payment process for the purchase.

Unfortunately, if the distribution of a digital content and the payment process are performed in response to an instruction for purchase by a user, the payment process is also performed upon an accidental instruction for purchase by the user, which may require cancellation of the payment process. In contrast, if for example the user is required to go through a plurality of screens/steps before confirmation of purchase to prevent accidental instructions for purchase by the user, the user cannot easily enjoy digital contents due to complex operations.

### SUMMARY

One object of the embodiments of the present invention is to allow users to enjoy digital contents more easily. Other objects of the present disclosure will be apparent with reference to the entire description in this specification.

A server according to an embodiment of the present invention is a server for providing a playback service of a digital content to a plurality of users each operating a terminal communicatively connected to the server, the server comprising: an information storage device configured to record, for each user, a possession state of virtual value to be consumed in response to playback of the digital content; and one or more processors capable of executing a program, wherein the program comprises: a screen sending module configured to send, in response to a request from the terminal, screen data of one or more playback service screens including a playback instruction screen for the user to make an instruction for playback of the digital content; a mode setting module configured to set, for each user, a playback starting mode selected from a plurality of modes including a first mode and a second mode and related to start of playback of the digital content a playback control module configured to start playback of the digital content in response to a playback instruction of the digital content and confirmation of consuming the virtual value in accordance with playback of the digital content from the user via the playback instruction screen if the playback starting mode for the user operating the terminal is set to the first mode, and configured to start playback of the digital content in response to the playback instruction from the user via the playback instruction screen if the playback starting mode is set to the second mode; and a possession state update module configured to update a possession state of the virtual value in response to playback of the digital content.

A method according to an embodiment of the present invention is a method for providing a playback service of a digital content to a plurality of users each operating a terminal communicatively connected to the server, the method comprising the steps of: recording, for each user, a possession state of virtual values to be consumed in response to playback of the digital content; and sending, in response to a request from the terminal, screen data of one or more playback service screens including a playback instruction screen for the users to make an instruction for playback of the digital content; setting, for each user, a playback starting mode selected from a plurality of modes including a first mode and a second mode and related to start of playback of the digital content; starting playback of the digital content in response to a playback instruction of the digital content and confirmation of consuming the virtual value in accordance with playback of the digital content from the user via the playback instruction screen if the playback starting mode for the user operating the terminal is set to the first mode, and starting playback of the digital content in response to the playback instruction from the user via the playback instruction screen if the playback starting mode is set to the second mode; and updating a possession state of the virtual value in response to playback of the digital content.

The embodiments of the present invention allow users to enjoy digital contents more easily.

### BRIEF DESCRIPTION OF THE DRAWINGS

FIG. 1 is a block diagram schematically illustrating a system including a server according to an embodiment of the present invention.

FIG. 2 is a block diagram illustrating modules included in a musical piece playback service program.

FIG. 3 is a diagram showing an example of a user information management table according to an embodiment.

FIG. 4 is a diagram showing an example of a playback list management table according to an embodiment.

FIG. 5 is a diagram showing an example of a follow user management table according to an embodiment.

FIG. 6 is a diagram showing an example of Main screen according to an embodiment.

FIG. 7 is a diagram showing an example of Main screen according to an embodiment.

FIG. 8 is a flow diagram showing an example of an individual playback process according to an embodiment.

FIG. 9 is a diagram showing an example of an individual playback instruction screen according to an embodiment.

FIG. 10 is a diagram showing an example of an individual playback instruction screen according to an embodiment.

FIG. 11 is a diagram showing an example of an individual playback instruction screen according to an embodiment.

FIG. 12 is a flow diagram showing an example of a sequential playback process according to an embodiment.

FIG. 13 is a diagram showing an example of a sequential playback instruction screen according to an embodiment.

FIG. 14 is a diagram showing an example of a sequential playback instruction screen according to an embodiment.

FIG. 15 is a diagram showing an example of a sequential playback instruction screen according to an embodiment.

FIG. 16 is a diagram showing an example of a playback ticket purchase screen according to an embodiment.

### DESCRIPTION OF EXAMPLE EMBODIMENTS

Various embodiments of the present invention will be described hereinafter with reference to the drawings. In the drawings, the same components are denoted by the same reference numerals.

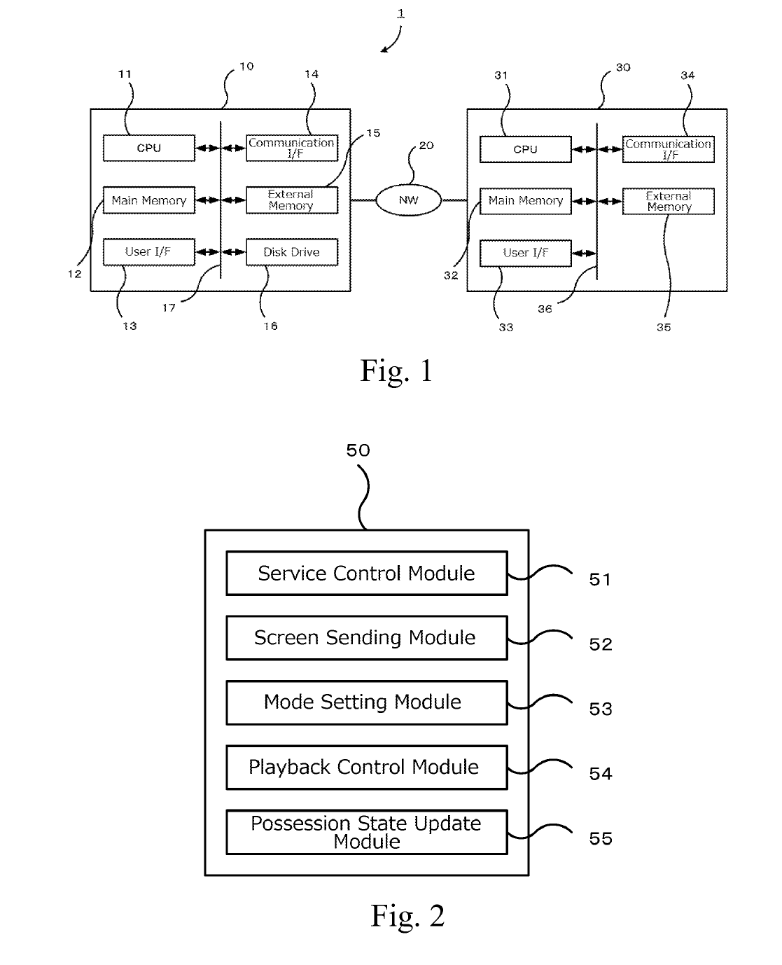

FIG. 1 is a block diagram schematically illustrating the configuration of a system 1 including a server 10 according to an embodiment of the present invention. As shown in FIG. 1, the server 10 according to an embodiment may be communicatively connected to a terminal 30 via a communication network 20 such as the Internet, and may provide various services including a playback service of musical pieces to a user operating the terminal 30. Additionally, the server 10 may be communicatively connected to terminals other than the terminal 30 and not shown. The server 10 may provide various digital contents (e.g., videos, electronic books, and games) other than musical pieces to the user operating the terminal 30, provide various Internet services other than provision of digital contents, and provide a platform service that implements various communications between a plurality of users operating a plurality of terminals 30.

As illustrated, the server 10 according to an embodiment may include a central processing unit (CPU) (processor) 11, a main memory 12, a user interface (I/F) 13, a communication I/F 14, an external memory 15, and a disk drive 16, and these components may be electrically connected to one another via a bus 17. The CPU 11 may load an operating system and various programs into the main memory 12 from the external memory 15, and may execute commands included in the loaded programs. The main memory 12 may be used to store a program to be executed by the CPU 11, and may be formed of, for example, a dynamic random access memory (DRAM).

The user I/F 13 may include, for example, an information input device such as a keyboard or a mouse for accepting an input from an operator, and an information output device such as a liquid crystal display for outputting calculation results of the CPU 11. The communication I/F 14 may be implemented as hardware, firmware, or communication software such as a transmission control protocol/Internet protocol (TCP/IP) driver or a point-to-point protocol (PPP) driver, or a combination thereof, and may be configured to be able to communicate with the terminals 30 via the communication network 20.

The external memory 15 may be formed of, for example, a magnetic disk drive and store a control program for controlling various services. The external memory 15 may also store various data used in the various services. The various data that may be stored in the external memory 15 may also be stored on a database server communicatively connected to the server 10 and physically separate from the server 10. The disk drive 16 may read data stored in a storage medium such as a compact disc read only memory (CD-ROM), digital versatile disc read only memory (DVD-ROM), or DVD Recordable (DVD-R) disc, or write data to such a storage medium. For example, applications stored in a storage medium and various data for use in providing the various services may be read by the disk drive 16, and may be installed into the external memory 15.

In an embodiment, the server 10 may be a web server for managing a web site including a plurality of hierarchical web pages and may be capable of providing the terminal 30 with various services. The terminals 30 may fetch HTML data for rendering a web page from the server 10 and analyze the HTML data to present the web page to a user of the terminals 30. The HTML data for rendering the web page may also be stored on the external memory 15. The HTML data may comprise HTML documents written in markup languages such as HTML; the HTML documents may be associated with various images. Additionally, the HTML documents may include programs written in script languages such as ActionScript™ and JavaScript™.

The external memory 15 may store applications to be executed on execution environments of the terminal 30 other than browser software. These applications may include programs for receiving various services and various data such as image data to be referred to for executing the programs. The programs may be created in, for example, object oriented languages such as Objective-C™ and Java™. The created programs may be stored on the external memory 15 in the form of application software along with various data. The application software stored on the external memory 15 may be delivered to a terminal 30 in response to a delivery request. The application software delivered from the server 10 may be received by the terminal 30 through a communication I/F 34 in accordance with the control of CPU 31; the received programs may be sent to an external memory 35 and stored thereon. The application software may be launched in accordance with the user's operation on the terminal 30 and may be executed on an execution environment implemented on the terminal 30 such as NgCore™ or Android™. The server 10 may provide the applications executed on the terminals 30 with various data required for various services. Additionally, the server 10 can store various data sent from the terminal 30 for each user, thereby managing the provision of the various services.

Thus, the server 10 may manage the web site for providing various services and deliver web pages constituting the web site in response to a request from the terminal 30, thereby providing various services to a user. Also, the server 10 can provide various services based on communication with an application performed on the terminal 30 in place of, or in addition to, such various browser-based services. Whichever mode may be taken to provide the services, the server 10 can store data required to provide the various services for each identification identifying a user. Briefly, the server 10 may also include a function to authenticate a user at start of various services and perform charging process in accordance with provision of various services.

In an embodiment, the terminal 30 may be any information processing device that may display on a web browser a web page of a web site for various services obtained from the server 10 and include an executing environment for executing applications; and the terminals 30 may include smartphones, tablet terminals, and game-dedicated terminals.

As shown, the terminal 30 may include a central processing unit (CPU) (processor) 31, a main memory 32, a user interface (I/F) 33, a communication I/F 34, and an external memory 35, and these components may be electrically connected to one another via a bus 36.

The CPU 31 may load various programs such as an operating system into the main memory 32 from the external memory 35, and may execute commands included in the loaded programs. The main memory 32 may be used to store a program to be executed by the CPU 31, and may be formed of, for example, a dynamic random access memory (DRAM).

The user I/F 33 may include, for example, an information input device such as a touch panel, a keyboard, a button, and a mouse for accepting an input from a user, and an information output device such as a liquid crystal display for outputting calculation results of the CPU 31. The communication I/F 34 may be implemented as hardware, firmware, or communication software such as a transmission control protocol/Internet protocol (TCP/IP) driver or a point-to-point protocol (PPP) driver, or a combination thereof, and may be configured to be able to communicate with the server 10 via the communication network 20.

The external memory 35 may comprise, for example, a magnetic disk drive or a flash memory and store various programs such as an operating system. When receiving an application from a server 10 via the communication I/F 34, the external memory 35 may store the received application.

A terminal 30 having such an architecture may include, for example, browser software for interpreting an HTML file (HTML data) and rendering a screen; this browser software may enable the terminal 30 to interpret the HTML data fetched from the server 10 and render web pages corresponding to the received HTML data. Further, the terminal 30 may include plug-in software (e.g., Flash Player distributed by Adobe Systems Incorporated) embedded into browser software; therefore, the terminal 30 can fetch from the server 10 a SWF file embedded in HTML data and execute the SWF file by using the browser software and the plug-in software.

When various services are received on the terminal 30, for example, animation or an operation icon designated by the program may be displayed on a screen of the terminal 30. The user may enter an instruction for receiving the various services using an input interface of the terminal 30. The instruction entered by the user may be transmitted to the server 10 through the browser of the terminal 30 or a function of an execution environment such as NgCore™.

Next, a musical piece playback service program 50 will be described, which is executed by the CPU 11 of the server 10 according to an embodiment. FIG. 2 is a block diagram illustrating examples of modules included in a musical piece playback service program 50. As shown, the musical piece playback service program 50 includes: a service control module 51 configured to control entire musical piece playback services; a screen sending module 52 configured to send, in response to a request from a terminal 30, screen data of a musical piece playback service screen including a playback instruction screen for a user to make an instruction for playback of a musical piece (a digital content); a mode setting module 53 configured to set, for each user, a playback starting mode related to start of musical piece playback and selected from a plurality of modes including Normal mode (first mode) and One-tap Playback mode (second mode); a playback control module 54 configured to start playback of a musical piece in response to a playback instruction of the musical piece from the user via a playback instruction screen and to confirmation of consuming a playback ticket (virtual value) for playback of the musical piece if the playback starting mode for the user operating the terminal 30 is set to Normal mode and configured to start playback of the musical piece in response to a playback instruction of the musical piece from the user via a playback instruction screen if the playback starting mode is set to One-tap Playback mode; and a possession state update module 55 configured to update a possession state of playback tickets in response to playback of the musical piece.

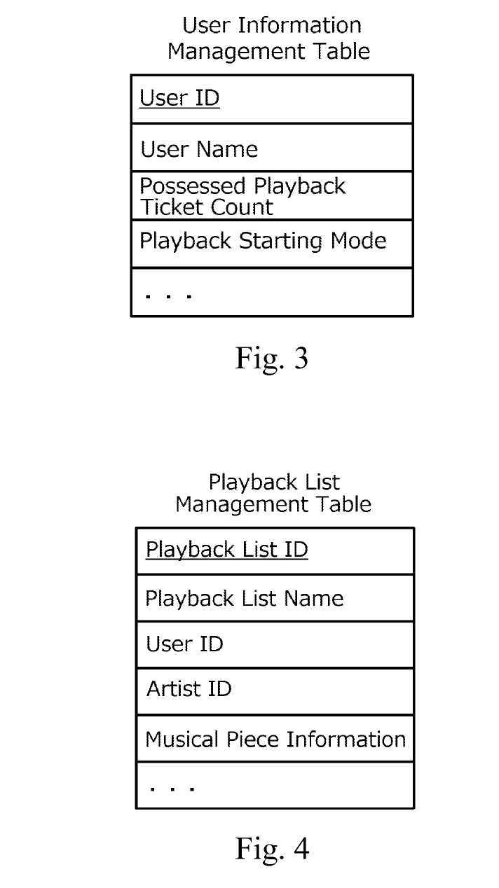

FIGS. 3 to 5 show examples of the user information management table, the playback list management table, and the follow user management table stored on, for example, the external memory 15 that serves as an information storage unit for storing information on the server 10. As shown in FIG. 3, the user information management table according to an embodiment may manage “user ID” identifying a user and information associated therewith such as “user name” indicating the name of the user, “possessed playback ticket count” indicating the number of playback tickets possessed by the user, and “playback starting mode” indicating the playback starting mode set for the user. In the musical piece playback service provided by the server 10 according to an embodiment, a user can select a playback method for playing back a musical piece from among the following three playback methods: “trial playback” wherein only a part (e.g., a melodious part) of the musical piece is played back by streaming, “full playback” wherein the entirety of the musical piece is played back by streaming; and “download” (purchase) wherein the entirety of the musical piece is downloaded. Among these three playback methods, “full playback” may require a playback ticket, a virtual ticket, to play back the musical piece, the number of the playback ticket possessed being managed by the “possessed playback ticket count.” More specifically, in an embodiment, one playback ticket is required to play back one musical piece by the playback method “full playback,” and each time one musical piece is played back by the playback method “full playback,” one playback ticket is consumed. The “playback starting mode” is related to start of playback of a musical piece and, in an embodiment, set to Normal mode or One-tap Playback mode. The operation in accordance with the “playback starting mode” will be described later.

As shown in FIG. 4, the playback list management table in an embodiment may manage “playback list ID” identifying a playback list and information associated therewith such as “playback list name” indicating the name of the playback list, “user ID” identifying the user who created the playback list, “artist ID” identifying the artist corresponding to the playback list, “musical piece information” containing information on the musical pieces included in the playback list. In an embodiment, a user can select a plurality of desired musical pieces to create a playback list, and the “musical piece information” may contain information on the plurality of musical pieces (e.g., IDs identifying the musical pieces, musical piece names, and the playback order). In an embodiment, the playback list management table may manage, e.g., information on a playback list created by a service provider of the musical piece playback service, in addition to a playback list created by the user (in this case, the “user ID” may contain information identifying the service provider). The “artist ID” may contain an artist ID identifying an artist when the playback list includes only musical pieces of the same artist.

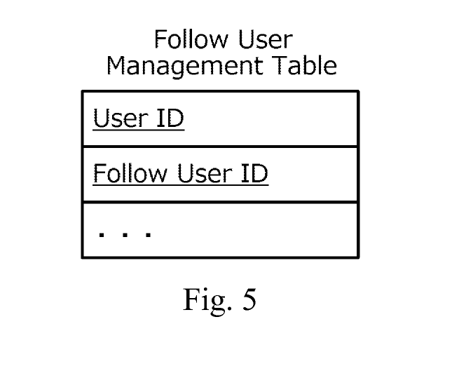

As shown in FIG. 5, the follow user management table in an embodiment may manage information related to the combination of “user ID” identifying a user and “follow user ID” identifying another user followed by (in a predetermined relationship with) the user. In an embodiment, a user following another user may be provided with information on the followed user (e.g., playback history of musical pieces or postings) which is inserted into his own feed information. The predetermined relationship may be various in addition to the relationship between a following user and a followed user. One example is friends formed by one user accepting a friend request from another user. Such predetermined relationships between users may be managed by a table similar to the follow user management table.

The external memory 15 of the server 10 may contain a musical piece database storing musical piece data of musical pieces to be provided users, in a file format such as Advanced Audio Coding (AAC) and Windows™ Media Audio (WMA). The musical piece database may manage musical piece names and related album names and artist names, etc. Such a musical piece database may not necessarily be located within the server 10, and may also be located in other systems, servers, or databases communicatively connected to the server 10.

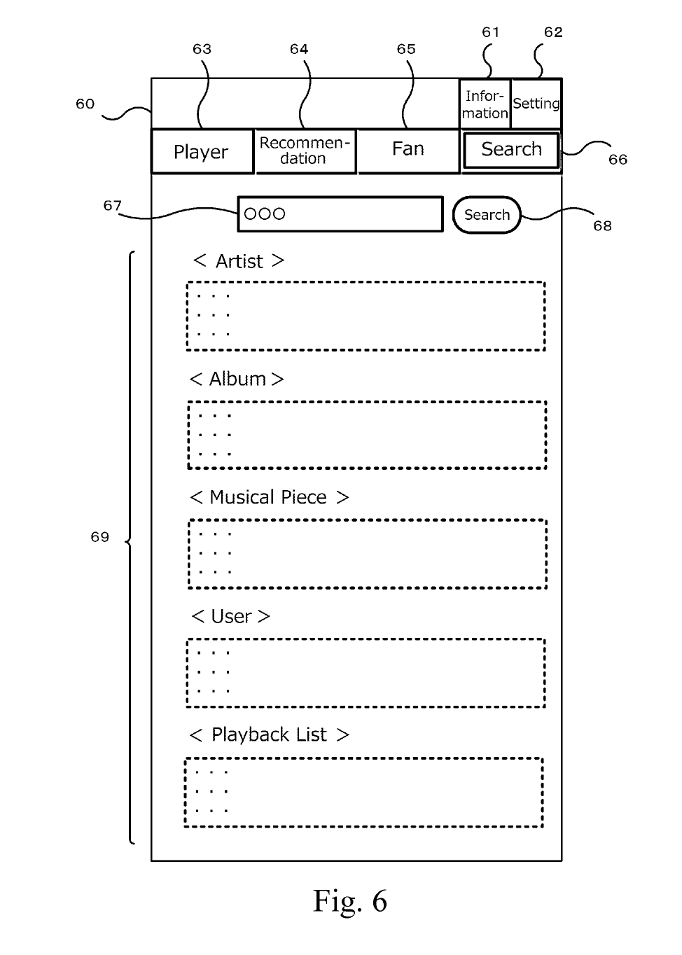

Next, operations of such a server 10 as an embodiment of the present invention will now be described. For convenience, Main screen 60 will be described first, which is a basic screen for a user to receive musical piece playback service. FIG. 6 shows an example of Main screen 60 displayed on a terminal 30. Main screen 60 may be displayed on a terminal 30 when an application for receiving musical piece playback service is started on the terminal 30 or when the user logs in a website provided by the server 10 for receiving musical piece playback service. As shown, Main screen 60 in an embodiment may contain, in the top right corner, an information button 61 for showing notification to a user and a setting button 62 for various settings related to the musical playback service; and below these buttons may be a player button 63 for playing back musical pieces stored on the terminal 30, a recommendation button 64 for showing information on musical pieces recommended to the user, a fan button 65 for showing feed information, such as articles and postings by other users, provided by a provider of the musical piece playback service, and a search button 66 for searching among artists, albums, musical pieces, other users, and playback lists. The settings accessible on selection of the setting button 62 may include the above-mentioned “playback starting mode.” FIG. 6 shows Main screen 60 upon selection of the search button 66, wherein below the above-mentioned buttons are displayed a search input region 67 and a search button 68. When the user inputs a desired character string into the search input region 67 and selects the search button 68, a search result for the character string as a search keyword is displayed in the display region 69 below. In an embodiment, the search result may include lists of artists, albums, musical pieces, other users, and playback lists found with the inputted character string as a search keyword. Of the information displayed in the search result, artists, albums, and musical pieces may be retrieved from the musical piece database, other users may be retrieved from the user information management table, and the playback lists may be retrieved from the playback list management table.

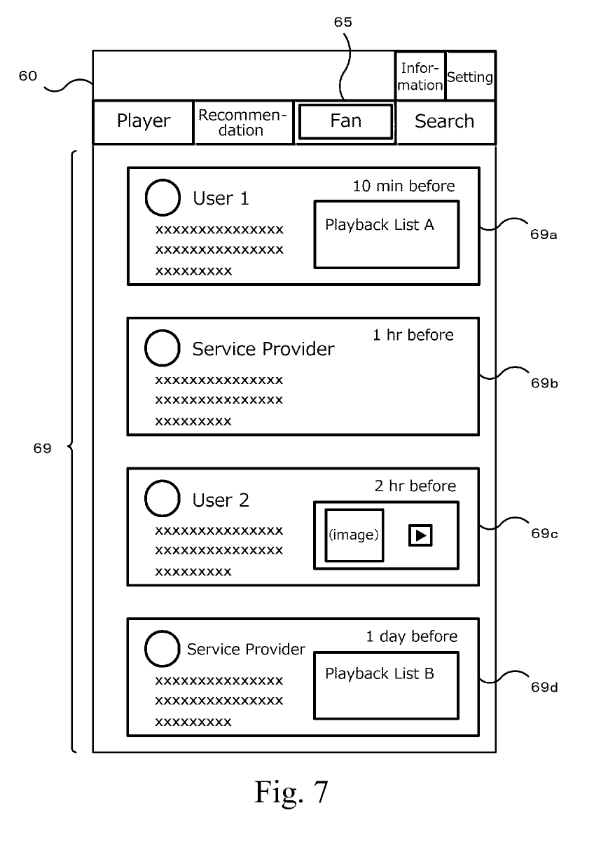

FIG. 7 shows Main screen 60 upon selection of the fan button 65, wherein the above-mentioned feed information such as articles and postings may be displayed in the display region 69. As described above, the feed information may include postings by other users (e.g., postings 69a and 69c) and articles provided by the service provider (e.g., articles 69b and 69d), which may be sorted by the recorded date. These postings and articles may be managed by a table (not shown) located in the external memory 15, etc. Further, the postings and articles may be stored in association with artists, genres (Japanese, Western, pops, rock, etc.), etc. such that only postings and articles related to artists and genres attracting the user may be extracted and inserted into the feed information. In this case, the user information management table may manage information on artists and genres attracting the user. Additionally, in this case, the artists and genres attracting the user may be determined based on the playback history of musical pieces by the user. Further, the feed information may include postings by another user in a predetermined relationship such as a user followed by the user (managed by the follow user management table). Still further, in an embodiment, postings and articles may be stored in association with musical pieces and playback lists. In this case, postings and articles displayed as feed information may be related to musical pieces (e.g., posting 69c) or related to playback lists (e.g., posting 69a and article 69d).

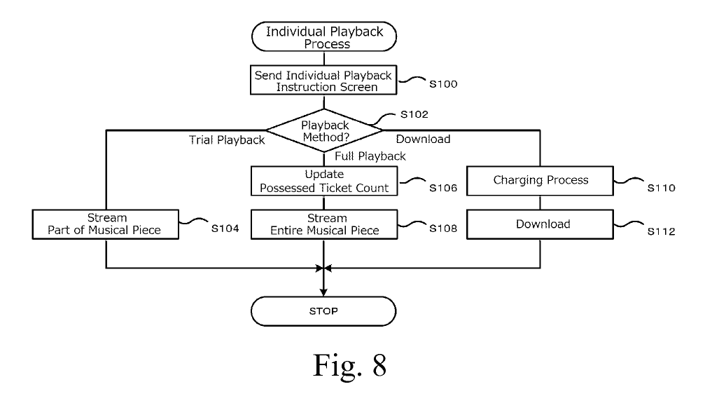

In such en embodiment wherein the musical piece playback service is provided to users via Main screen 60, a user can playback one individual musical piece and playback a plurality of musical pieces sequentially. First, the operation of playing back one individual musical piece will be described. FIG. 8 is a flow diagram showing an example of an individual playback process performed by the server 10. This process may be performed when the user selects an individual musical piece via Main screen 60 described above. A musical piece may be selected, e.g., from a list of musical pieces in a search result or from musical pieces associated with postings and articles included in the feed information.

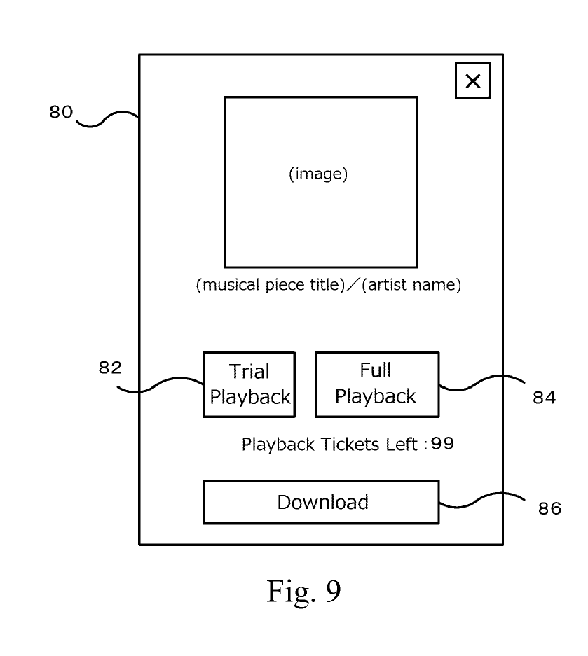

As shown in FIG. 8, the first step of the individual playback process may be to send the screen data of the individual playback instruction screen 80 to the terminal 30 (step S100). FIG. 9 shows an example of the individual playback instruction screen 80 displayed on the terminal 30 having received the screen data. As shown, the individual playback instruction screen 80 in an embodiment may contain an image corresponding to the musical piece along with the musical piece name and the artist name; and displayed therebelow may be a trial playback button 82 for making an instruction for playback of the musical piece by the playback method “trial playback,” a full playback button 84 for making an instruction for playback of the musical piece by the playback method “full playback,” and a download button 86 for making an instruction for playback of the musical piece by the playback method “download” Displayed below the full playback button 84 may be the number of playback tickets possessed by the user operating the terminal 30 (managed by the user information management table). When the user operating the terminal 30 selects the trial playback button 82, the terminal 30 may send to the server 10 data for requesting playback of the musical piece by the playback method “trial playback”; When the user operating the terminal 30 selects the download button 86, the terminal 30 may send to the server 10 data for requesting playback of the musical piece by the playback method “download.”

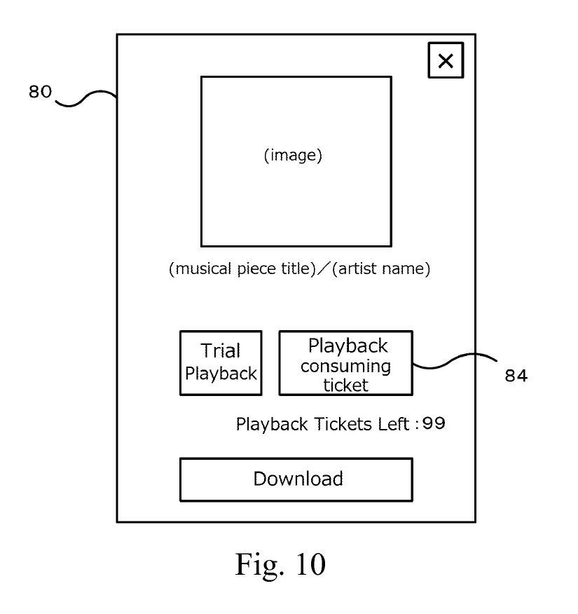

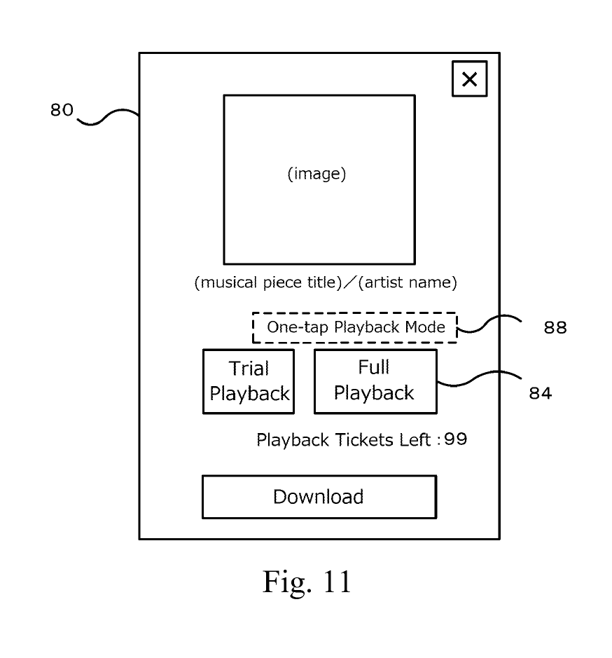

A description will be given of the display and operation of the individual playback instruction screen 80, and particularly the full playback button 84, in accordance with the “playback starting mode” for the user operating the terminal 30. The individual playback instruction screen 80 shown in FIG. 9 is in the case where the “playback starting mode” for the user is set to Normal mode. In this case, when the user selects the full playback button 84, the character string displayed on the full playback button 84 may be changed from “Full Playback” to “Playback consuming ticket,” as shown in FIG. 10. If the full playback button 84, now showing the character string “Playback consuming ticket,” is selected again, the terminal 30 may send to the server 10 data for requesting playback of the musical piece by the playback method “full playback.” The individual playback instruction screen 80 shown in FIG. 11 is in the case where the “playback starting mode” for the user is set to One-tap Playback mode. As shown, one-tap playback mode notification information 88 is displayed above the full playback button 84, which indicates that the “playback starting mode” is set to One-tap Playback mode. In this case, when the user selects the full playback button 84, the terminal 30 may immediately send to the server 10 data for requesting playback of the musical piece by the playback method “full playback.” Thus, when the “playback starting mode” is set to Normal mode, the full playback button 84 (a selection region) in the individual playback instruction screen 80 in an embodiment may receive an instruction for playback upon the first selection operation by the user and receive confirmation of consuming a playback ticket upon the second selection operation by the user; and when the “playback starting mode” is set to One-tap Playback mode, the full playback button 84 may receive an instruction for playback upon one selection operation by the user. Additionally, it may also be possible that, when the user selects the above-described one-tap playback mode notification information 88, a screen for the user to set the “playback starting mode” (e.g., a screen displayed when the user selects the setting button 62 in Main screen 60) should be displayed.

Referring back to the flow diagram in FIG. 8, if, upon operation on the individual playback instruction screen 80 by the user, the server 10 receives from the terminal 30 data for requesting playback of the musical piece by the playback method “trial playback” (step S102), a part of the musical piece may be delivered by streaming (step S104) and the individual playback process may be terminated. More specifically, musical piece data for “trial playback” (musical piece data corresponding to part of the musical piece) stored on the musical piece database may be delivered to the terminal 30 by streaming using a protocol such as RTSP. The musical piece data delivered by such streaming may be tentatively stored on the terminal 30 as cache data and then deleted to restrict reuse on the terminal 30. Part or whole of the musical piece data delivered by streaming may also be previously buffered on the terminal 30.

Meanwhile, if, upon operation on the individual playback instruction screen 80 by the user, the server 10 receives from the terminal 30 data for requesting playback of the musical piece by the playback method “full playback” (step S102), the number of playback tickets possessed by the user may be updated (step S106). More specifically, the “possessed playback ticket count” in the user information management table may be decremented by “1.” If the number of playback tickets possessed by the user is “0,” the full playback button 84 in the individual playback instruction screen 80 may be previously disabled, or a screen prompting the user to purchase playback tickets may be displayed when the full playback button 84 is selected.

After updating the number of possessed playback ticket, the server 10 may deliver the entire musical piece by streaming (step S108) and terminate the individual playback process. More specifically, musical piece data for “full playback” (musical piece data corresponding to the entirety of the musical piece) stored on the musical piece database may be delivered to the terminal 30 by streaming using a protocol such as RTSP. If the streaming of the entirety of the musical piece by the playback method “full playback” is started and then canceled before completion of delivery, the consumption of the playback ticket may be canceled (more specifically, the “possessed playback ticket count” may be incremented by “1”), or the streaming of the entirety of the musical piece may be repeated in response to a request from the user instead of cancellation of playback ticket consumption. Alternatively, the number of possessed playback tickets may be updated after streaming of the entirety of the musical piece has been completed, not before streaming of the entirety of the musical piece is started. The musical piece data delivered by such streaming may be tentatively stored on the terminal 30 as cache data and then deleted to restrict reuse on the terminal 30, as with the playback method “trial playback” described above. Part or whole of the musical piece data delivered by streaming may also be previously buffered on the terminal 30, as with the playback method “trial playback” described above.

Meanwhile, if, upon operation on the individual playback instruction screen 80 by the user, the server 10 receives from the terminal 30 data for requesting playback of the musical piece by the playback method “download” (step S102), a charging process may be performed for purchase of the musical piece (step S110). The charging process may be performed by using various payment services provided by credit card companies or mobile phone carriers. For example, a desired payment method can be selected from a plurality of payment methods preset by the user, and a payment process can be performed by the selected payment method. Since such a charging process is conventional, further detailed description will be omitted.

After the charging process is performed, the server 10 may deliver the musical piece by download (step S112), and may terminate the individual playback process. More specifically, musical piece data stored on the musical piece database may be transferred to the terminal 30 by using HTTP, etc. When the file transfer is completed in the download, the terminal 30 may playback the musical piece data using plug-in software included in browser software or using an application. The musical piece data delivered by such download may be kept stored on the terminal 30 for reuse on the terminal 30. In an embodiment, the download of the musical piece data may be performed after the charging process; alternatively, it may also be possible that the individual playback process should be terminated after the charging process is performed and the download should be performed at any timing desired by the user. In the above example, the musical piece data may be transferred to the terminal 30; alternatively, it may also be possible that the musical piece data should be transferred to a device designated by the user other than the terminal 30.

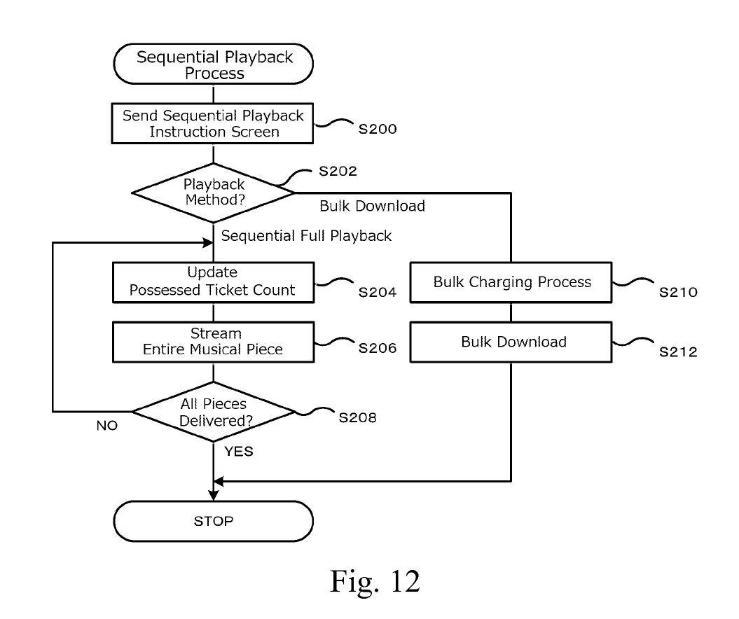

The foregoing was the description of the operation of playing back one individual musical piece. Next, the operation of playing back a plurality of musical pieces sequentially. FIG. 12 is a flow diagram showing an example of a sequential playback process performed by the server 10. This process may be performed when the user selects a playback list via Main screen 60 described above. A playback list may be selected, e.g., from a list of playback lists in a search result or from playback lists associated with postings and articles included in the feed information.

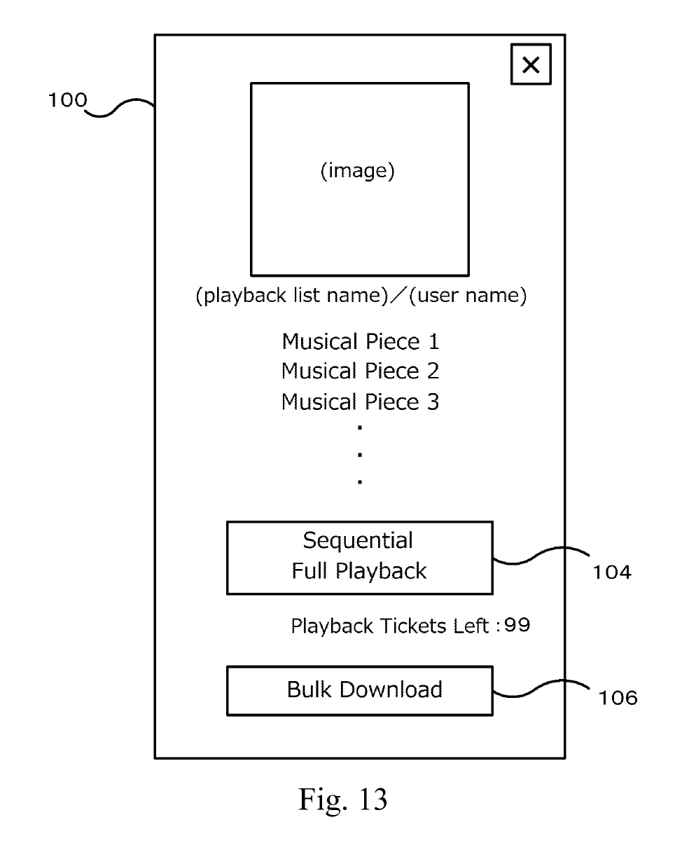

As shown, the first step of the sequential playback process may be to send the screen data of the sequential playback instruction screen 100 to the terminal 30 (step S200). FIG. 13 shows an example of the sequential playback instruction screen 100 displayed on the terminal 30 having received the screen data. As shown, the sequential playback instruction screen 100 in an embodiment may contain an image corresponding to the playback list along with the playback list name, the user name (or the artist name), and a plurality of musical piece names constituting the playback list; and displayed therebelow may be a sequential full playback button 104 for making an instruction for a sequential playback of the musical pieces constituting the playback list by the playback method “full playback,” and a bulk download button 106 for making an instruction for a bulk download of the musical pieces constituting the playback list by the playback method “download” Displayed below the sequential full playback button 104 may be the number of playback tickets possessed by the user operating the terminal 30. When the user operating the terminal 30 selects the bulk download button 106, the terminal 30 may send to the server 10 data for requesting a bulk download by the playback method “download.”

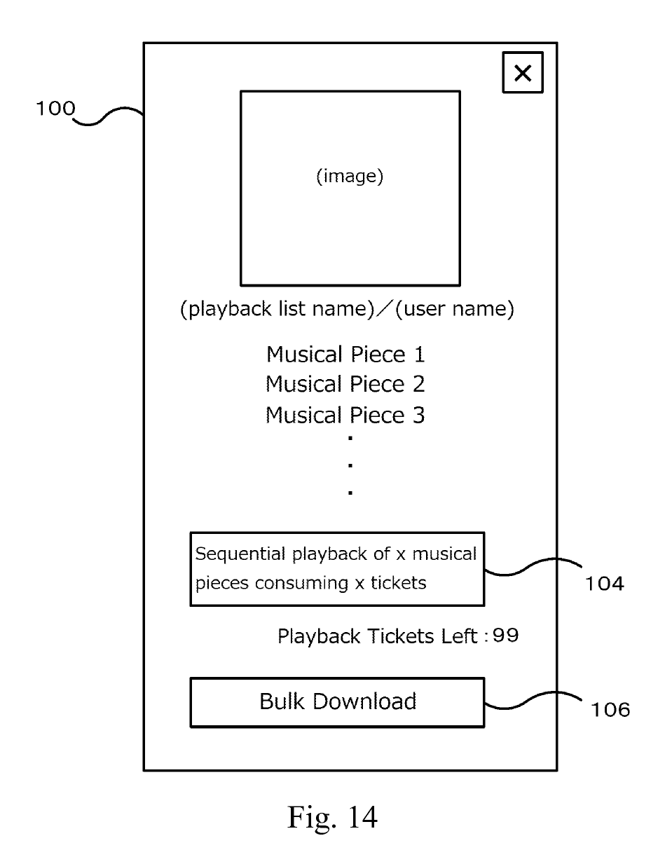

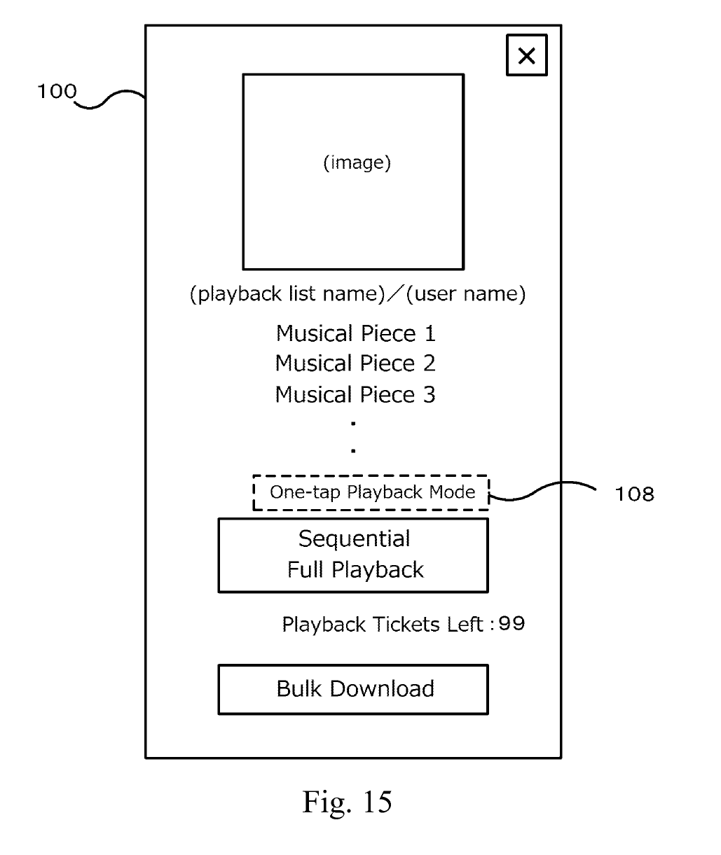

A description will be given of the display and operation of the sequential playback instruction screen 100, and particularly the sequential full playback button 104, in accordance with the “playback starting mode” for the user operating the terminal 30. The sequential playback instruction screen 100 shown in FIG. 13 is in the case where the “playback starting mode” for the user is set to Normal mode. In this case, when the user selects the sequential full playback button 104, the character string displayed on the sequential full playback button 104 may be changed from “Sequential Full Playback” to “Sequential playback of x musical pieces consuming x tickets,” as shown in FIG. 14. The number x of musical pieces to be sequentially played back may be based on the number of musical pieces constituting the playback list and the number x of consumed tickets may be associated with (e.g., equal to) the number of musical pieces to be sequentially played back. If the sequential full playback button 104, now showing the character string “Sequential playback of x musical pieces consuming x tickets,” is selected again, the terminal 30 may send to the server 10 data for requesting sequential playback of the musical pieces by the playback method “full playback.” The sequential playback instruction screen 100 shown in FIG. 15 is in the case where the “playback starting mode” for the user is set to One-tap Playback mode. As shown, one-tap playback mode notification information 108 is displayed above the sequential full playback button 104, which indicates that the “playback starting mode” is set to One-tap Playback mode. In this case, when the user selects the sequential full playback button 104, the terminal 30 may immediately send to the server 10 data for requesting sequential playback of the musical piece by the playback method “full playback.” Thus, when the “playback starting mode” is set to Normal mode, the sequential full playback button 104 (a selection region) in the sequential playback instruction screen 100 in an embodiment may receive an instruction for sequential playback upon the first selection operation by the user and receive confirmation of consuming playback tickets upon the second selection operation by the user; and when the “playback starting mode” is set to One-tap Playback mode, the sequential full playback button 104 may receive an instruction for sequential playback upon one selection operation by the user. Additionally, it may also be possible that, when the user selects the above-described one-tap playback mode notification information 108, a screen for the user to select the playback starting mode (e.g., a screen displayed when the user selects the setting button 62 in Main screen 60) should be displayed.

Referring back to the flow diagram in FIG. 12, if, upon operation on the sequential playback instruction screen 100 by the user, the server 10 receives from the terminal 30 data for requesting sequential playback of the musical pieces by the playback method “full playback” (step S202), the server 10 may sequentially repeat (step S208), for each of the musical pieces constituting the playback list, update of the number of possessed playback tickets (step S204) and delivery of the entire musical pieces by streaming (step S206), which are the same as steps S106 and S108 of the individual playback process described above, respectively and terminate the sequential playback process. Instead of such a process, the server 10 may update the number of possessed playback tickets in step S204 by subtracting the total number of playback tickets required for playback of all the musical pieces constituting the playback list (e.g., if the playback list includes ten musical pieces, ten may be subtracted from the number of possessed playback tickets), and sequentially repeat only delivery of the entire musical pieces by streaming in step S206.

Meanwhile, if, upon operation on the sequential playback instruction screen 100 by the user, the server 10 receives from the terminal 30 data for requesting a bulk download of the musical pieces by the playback method “download” (step S202), a charging process may be performed for purchase of all the musical pieces constituting the playback list (step S210). After the charging process is performed, the server 10 may deliver the musical pieces by a bulk download (step S212), and may terminate the sequential playback process. In the above example, the musical pieces may be played back based on the playback list selected by the user. In addition to or in place of such an operation, the user may select an album including a plurality of musical pieces for sequential playback of musical pieces based on the selected album. As with the playback list, an album may be selected, e.g., from a list of albums in a search result or from albums associated with postings and articles included in the feed information.

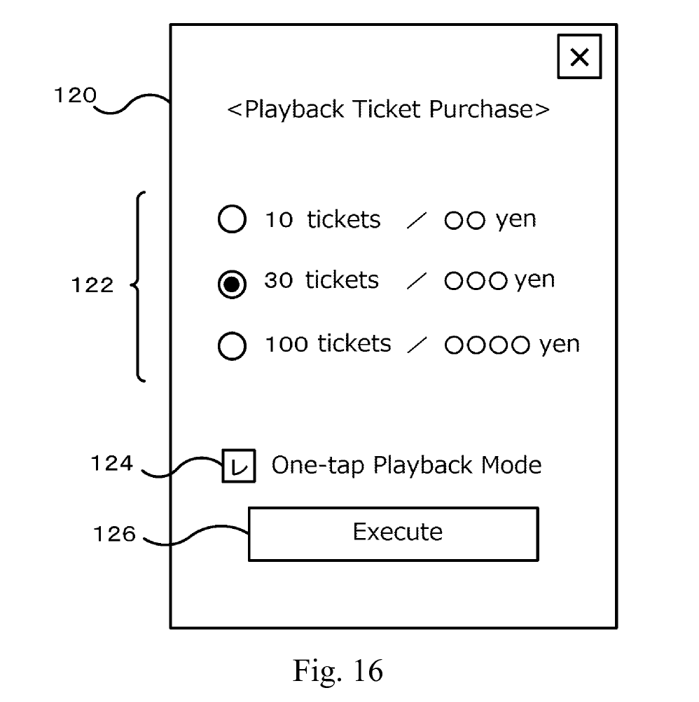

The foregoing was the description of the operation of playing back a plurality of musical pieces sequentially. Next, the operation of obtaining playback tickets by a user will be described. In an embodiment, a user can obtain playback tickets at various opportunities. FIG. 6 shows an example of a playback ticket purchase screen 120 for a user to purchase playback tickets. As shown, the playback ticket purchase screen 120 in an embodiment contains: a ticket count selection region 122 for selecting the number of playback tickets to be purchased; a one-tap playback mode setting checkbox 124 for setting the “playback starting mode” to One-tap Playback mode; and an execute button 126. The user can select the number of tickets to be purchased (10, 30, or 100 in the example shown in FIG. 16) in the ticket count selection region 122 and select the execute button 126, thereby to purchase the selected number of playback tickets. If the user checks the one-tap playback mode setting checkbox 124, the “playback starting mode” may be set to One-tap Playback mode simultaneously with purchase of the playback tickets. In an embodiment, the user can obtain playback tickets when some are provided from another user as a present or when some are provided from a service provider as a bonus, as well as by purchasing playback tickets via the playback ticket purchase screen 120 shown in FIG. 16. A screen for the user to confirm such acquisition of playback tickets may also allow the user to set the “playback starting mode” as the playback ticket purchase screen 120. Thus, the screens related to acquisition of playback tickets may allow setting of the “playback starting mode,” so as to prompt the user to set the mode related to start of playback of musical pieces by the playback method “full playback” that may require playback tickets, at the opportunity of acquisition of playback tickets.

The above-described server 10 in an embodiment may allow setting of the playback starting mode related to start of playback of musical pieces for each user. When the playback starting mode is set to Normal mode (a first mode), the server 10 may start delivery of entirety of musical pieces by streaming in response to an instruction for playback via the individual playback instruction screen 80 or the sequential playback instruction screen 100 (playback instruction screens) and confirmation of consuming playback tickets (virtual value); and when the playback starting mode is set to One-tap Playback mode (a second mode), the server 10 may start delivery of entirety of musical pieces by streaming in response to an instruction for playback via the individual playback instruction screen 80 or the sequential playback instruction screen 100. Accordingly, it can be selected in accordance with the playback starting mode whether playback is started in accordance with an instruction for playback and confirmation of consuming playback tickets or whether playback is started in accordance with an instruction for playback only. As a result, the user can enjoy delivery of the entirety of musical pieces by streaming with playback tickets and, when the playback starting mode is set to One-tap Playback mode, the user can enjoy musical pieces more easily without confirmation of consuming playback tickets.

In an embodiment, when the “playback starting mode” is set to Normal mode, the full playback button 84 (the sequential full playback button 104) in the individual playback instruction screen 80 (the sequential playback instruction screen 100) may receive an instruction for playback (an instruction for sequential playback) upon the first selection operation by the user and receive confirmation of consuming a playback ticket upon the second selection operation by the user; and when the “playback starting mode” is set to One-tap Playback mode, the full playback button 84 may receive an instruction for playback (an instruction for sequential playback) upon one selection operation by the user. Accordingly, the same full playback button 84 (the sequential full playback button 104) may be used for both Normal mode and One-tap Playback mode; and thus the operability to the user can be retained even when the “playback starting mode” is changed.

In an embodiment, when the “playback starting mode” is set to Normal mode, the full playback button 84 (the sequential full playback button 104) in the individual playback instruction screen 80 (the sequential playback instruction screen 100) may receive an instruction for playback (an instruction for sequential playback) upon the first selection operation by the user and receive confirmation of consuming a playback ticket upon the second selection operation by the user; alternatively, the full playback button 84 may also receive an instruction for playback and confirmation of consuming a playback ticket upon three or more selection operations. For example, confirmation of consuming a playback ticket may be received upon a plurality of selection operations

In an embodiment, the same full playback button 84 (the sequential full playback button 104) may be used for both Normal mode and One-tap Playback mode; alternatively, different buttons (regions) may be used for receiving an instruction for playback and confirmation of consuming playback tickets in Normal mode and for receiving an instruction for playback in One-tap Playback mode. Further, the configuration of the individual playback instruction screen 80 (the sequential playback instruction screen 100) may be varied depending on whether the “playback starting mode” is set to Normal mode or One-tap Playback mode.

In an embodiment, one playback ticket may be required for playback of one musical piece by the playback method “full playback”; alternatively, a plurality of playback tickets may be required for playback of one musical piece, or one playback ticket may be used for playback of a plurality of musical pieces. Further, in an individual playback process, one playback ticket may be consumed for playback of one musical piece; in contrast, in a sequential playback process, a smaller number of playback tickets may be required per one musical piece; for example, five playback tickets may be consumed for playback of seven musical pieces. Further, playback tickets may be required for playback of musical pieces by the playback method “trial playback” or “download” instead of “full playback.” Even in this case, start of playback of a musical piece by the playback method “trial playback” or “download” can be controlled in accordance with the “playback starting mode” for the user.

In an embodiment, playback ticket is one example of virtual values required for playback of one musical piece by the playback method “full playback”; alternatively, virtual values other than playback tickets, such as points or virtual currency, may be applied.

The above description for the embodiments was focused on services for playback of musical pieces as an example of digital contents; and the processes and procedures described herein may be applied to servers for providing playback services of various digital contents including videos, electronic books, and games.

The processes and procedures described and illustrated herein may also be implemented by software, hardware, or any combination thereof other than those explicitly stated for the embodiments. More specifically, the processes and procedures described and illustrated herein may be implemented by the installation of the logic corresponding to the processes into a medium such as an integrated circuit, a volatile memory, a non-volatile memory, a magnetic disk, or an optical storage. The processes and procedures described and illustrated herein may also be installed in the form of a computer program, and executed by various computers.

Even if the processes and the procedures described herein are executed by a single apparatus, software piece, component, or module, such processes and procedures may also be executed by a plurality of apparatuses, software pieces, components, and/or modules. Even if the data, tables, or databases described herein are stored in a single memory, such data, tables, or databases may also be dispersed and stored in a plurality of memories included in a single apparatus or in a plurality of memories dispersed and arranged in a plurality of apparatuses. The elements of the software and the hardware described herein can be integrated into fewer constituent elements or can be decomposed into more constituent elements.

With respect to the use of substantially any plural and/or singular terms herein, those having skill in the art can translate from the plural to the singular and/or from the singular to the plural as is appropriate to the context.

What is claimed is:

1. A server for providing a playback service of a digital content to a plurality of users each operating a terminal communicatively connected to the server, the server comprising:
an information storage device configured to record, for each user, a possession state of virtual value to be consumed in response to playback of the digital content; and
one or more processors capable of executing a program,
wherein the program comprises:
a screen sending module configured to send, in response to a request from the terminal, screen data of one of one or more playback service screens including a playback instruction screen for the user to make an instruction for playback of the digital content;
a mode setting module configured to set, for each user, a playback starting mode selected from a plurality of modes including a first mode and a second mode and related to start of playback of the digital content;
a playback control module configured to start playback of the digital content in response to a playback instruction of the digital content and confirmation of consuming the virtual value in accordance with playback of the digital content from the user via the playback instruction screen if the playback starting mode for the user operating the terminal is set to the first mode, and configured to start playback of the digital content in response to the playback instruction from the user via the playback instruction screen if the playback starting mode is set to the second mode; and
a possession state update module configured to update the possession state of the virtual value in response to playback of the digital content,
wherein the playback instruction screen contains a selection region for receiving from the user the playback instruction and the confirmation of consuming the virtual value upon two or more selection operations by the user if the playback starting mode is set to the first mode, and receiving from the user the playback instruction upon one selection operation by the user if the playback starting mode is set to the second mode.

2. The server of claim 1 wherein, if the playback starting mode is set to the first mode, the selection region in the playback instruction screen receives the playback instruction upon the first selection operation by the user and receives the confirmation of consuming the virtual value upon the last one of the two or more selection operations by the user.

3. The server of claim 1, wherein
the one or more playback service screens include a virtual value acquisition-related screen related to acquisition of the virtual value by the user and allowing selection of the playback starting mode, and
the mode setting module sets the playback starting mode in accordance with selection by the user via the virtual value acquisition-related screen.

4. The server of claim 1, wherein
the playback instruction screen allows an instruction for sequential playback wherein a plurality of digital contents are sequentially played back, and
upon the instruction for the sequential playback, the playback control module starts the sequential playback in response to the instruction for the sequential playback and confirmation of consuming the virtual value in accordance with the sequential playback from the user via the playback instruction screen if the playback starting mode is set to the first mode, and starts the sequential playback in response to the instruction for the sequential playback from the user via the playback instruction screen if the playback starting mode is set to the second mode.

5. The server of claim 4 wherein the playback instruction screen allows an instruction for the sequential playback based on a playback list specifying a plurality of digital contents for the sequential playback.

6. The server of claim 5, wherein
the information storage device stores one or more playback lists created by the user such that the one or more playback lists are accessible to the user and other users including a user in a predetermined relationship with the user, and
the playback instruction screen allows an instruction for the sequential playback based on the playback list selected from the one or more playback lists stored on the information storage device.

7. The server of claim 1, wherein the virtual value comprises one or more virtual tickets, and a predetermined number of virtual tickets are consumed for each playback of one digital content.

8. A method for providing a playback service of a digital content to a plurality of users each operating a terminal communicatively connected to the server, the method comprising the steps of:
recording, for each user, a possession state of virtual values to be consumed in response to playback of the digital content; and
sending, in response to a request from the terminal, screen data of one of one or more playback service screens including a playback instruction screen for the users to make an instruction for playback of the digital content;
setting, for each user, a playback starting mode selected from a plurality of modes including a first mode and a second mode and related to start of playback of the digital content;
starting playback of the digital content in response to a playback instruction of the digital content and confirmation of consuming the virtual value in accordance with playback of the digital content from the user via the playback instruction screen if the playback starting mode for the user operating the terminal is set to the first mode, and starting playback of the digital content in response to the playback instruction from the user via the playback instruction screen if the playback starting mode is set to the second mode; and
updating the possession state of the virtual value in response to playback of the digital content,
wherein the playback instruction screen contains a selection region for receiving from the user the playback instruction and the confirmation of consuming the virtual value upon two or more selection operations by the user if the playback starting mode is set to the first mode, and receiving from the user the playback instruction upon one selection operation by the user if the playback starting mode is set to the second mode.

9. The method of claim 8, wherein
the one or more playback service screens include a virtual value acquisition-related screen related to acquisition of the virtual value by the user and allowing selection of the playback starting mode, and
the playback starting mode is set in accordance with selection by the user via the virtual value acquisition-related screen.

10. The method of claim 8, wherein
the playback instruction screen allows an instruction for sequential playback wherein a plurality of digital contents are sequentially played back, and
in the step of starting playback of the digital content, upon the instruction for the sequential playback, the sequential playback is started in response to the instruction for the sequential playback and confirmation of consuming the virtual value in accordance with the sequential playback from the user via the playback instruction screen if the playback starting mode is set to the first mode, and the sequential playback is started in response to the instruction for the sequential playback from the user via the playback instruction screen if the playback starting mode is set to the second mode.

11. The method of claim 8, wherein the virtual value comprises one or more virtual tickets, and a predetermined number of virtual tickets are consumed for each playback of one digital content.
